(19) United States
(12) Patent Application Publication
(10) Pub. No.: US 2009/0040537 A1
(43) Pub. Date: Feb. 12, 2009

(54) IMAGE FORMING APPARATUS PROVIDED WITH DISPLAY DEVICE, DISPLAY METHOD, DISPLAY PROGRAM, SCREEN GENERATING METHOD, AND SCREEN GENERATING PROGRAM

(75) Inventors: Hidetaka Iwai, Itami-shi (JP); Hisashi Uchida, Kuze-gun (JP); Ayumi Itoh, Nara-ken (JP); Keisuke Teramoto, Itami-shi (JP); Yoichi Kawabuchi, Itami-shi (JP)

Correspondence Address: MORRISON & FOERSTER LLP, 1650 TYSONS BOULEVARD, SUITE 400, MCLEAN, VA, 22102, US

(73) Assignee: Konica Minolta Business Technologies, Inc., Tokyo (JP)

(21) Appl. No.: 12/176,060

(22) Filed: Jul. 18, 2008

(30) Foreign Application Priority Data
Aug. 7, 2007 (JP) 2007-205317

(51) Int. Cl. G06K 15/02; G06K 15/00

(52) U.S. Cl. 358/1.2; 358/1.16

(57) ABSTRACT

The MFP includes an EEPROM storing display screens, and a display control portion to read a display screen for display on a display portion. When a first area in the display screen includes a variable display item for which an arbitrary number of data pieces are displayed, the display control portion acquires the number of data pieces to be displayed therefor, changes the size of a field for the variable display item based on the acquired number of data pieces, determines the size of a second area based on the size of the first area after the size change of the variable display item field and the size of the display area of the display portion, and modifies the read display screen to a display screen having the first area after the size change of the variable display item field and the second area of the determined size arranged therein.

This application is based on Japanese Patent Application No. 2007-205317 filed with Japan Patent Office on Aug. 7, 2007, the entire content of which is hereby incorporated by reference.

### BACKGROUND OF THE INVENTION

1. Field of the Invention

The present invention relates to an image forming apparatus, a display method, a display program, a screen generating method, and a screen generating program, and more particularly to an image forming apparatus provided with a display device, a display method for displaying a screen on the display device, a display program, a screen generating method for generating the screen, and a screen generating program.

2. Description of the Related Art

A user of an image forming apparatus is required to perform settings necessary to cause it to carry out various functions including scanning, copying, facsimile transmission/reception and the like. To facilitate such a setting operation, the image forming apparatus is provided with a display device for displaying an operation screen. In recent years, an image forming apparatus has been introduced which causes an advertisement to be displayed on the display device in addition to the operation screen. For example, Japanese Patent Laid-Open No. 2006-343992 discloses an image forming apparatus which displays an advertisement in response to a first print start instruction, and starts printing processing in response to a second print start instruction.

With the image forming apparatus disclosed in Japanese Patent Laid-Open No. 2006-343992, however, the advertisement is displayed only after there is a print instruction, and only for a limited period of time after issuance of the print instruction. Furthermore, since the advertisement is displayed on an area of a predetermined size, if the display area is small, it will be difficult for a user to see advertisements having a large amount of information.

### SUMMARY OF THE INVENTION

The present invention has been accomplished in view of the foregoing problems, and an object of the present invention is to provide an image forming apparatus capable of increasing the size of a prescribed area to the greatest extent possible, a display method, and a display program.

Another object of the present invention is to provide an image forming apparatus capable of generating a display screen having a prescribed area increased in size to the greatest extent possible, a screen generating method, and a screen generating program.

In order to achieve the object, according to an aspect of the present invention, there is provided an image forming apparatus which includes: a display portion having a display area of a predetermined size; a storage portion to store a display screen to be displayed on the display portion; and a display control portion to read the display screen from the storage portion for display on the display portion, wherein the display control portion includes: a data acquiring portion, when a first area included in the display screen includes, as an item to be displayed, a variable display item for which an arbitrary number of data pieces are displayed, to acquire the number of data pieces for display as the variable display item; a size change portion to change a size of a field for the variable display item based on the acquired number of data pieces; and a screen information modification portion to modify the read display screen to a display screen in which the first area after the change in size of the field for the variable display item and a second area different from the first area are arranged, based on the size of the first area after the change in size of the field for the variable display item.

According to another aspect of the present invention, there is provided an image forming apparatus which includes: a display portion having a display area of a predetermined size; an identification information accepting portion to accept user identification information for identification of a user; an item accepting portion to accept designation of at least one of a plurality of display items; a first area determination portion to determine a size of a first area based on a display size predetermined for the display item specified by the accepted designation; a screen generation portion to generate a new display screen having the first area and a second area different from the first area arranged based on the determined size of the first area; and a storage portion to store the generated new display screen in association with the user identification information.

According to a further aspect of the present invention, there is provided a display method executed by an image forming apparatus, the image forming apparatus including a display portion having a display area of a predetermined size and a storage portion to store a display screen to be displayed on the display portion, wherein the display method includes the steps of: reading the display screen for display on the display portion from the storage portion; when a first area included in the read display screen includes, as an item to be displayed, a variable display item for which an arbitrary number of data pieces are displayed, acquiring the number of data pieces for display as the variable display item; changing a size of a field for the variable display item based on the acquired number of data pieces; and based on the size of the first area after the change in size of the field for the variable display item, modifying the read display screen to a display screen in which the first area after the change in size of the field for the variable display item and a second area different from the first area are arranged.

According to a still further aspect of the present invention, there is provided a screen generating method carried out by an image forming apparatus provided with a display portion having a display area of a predetermined size, wherein the screen generating method includes the steps of: accepting user identification information for identification of a user; accepting designation of at least one of a plurality of display items; determining a size of a first area based on a display size predetermined for the display item specified by the accepted designation; generating a new display screen having the first area and a second area different from the first area arranged therein based on the determined size of the first area; and storing the generated new display screen in association with the user identification information.

According to yet another aspect of the present invention, there is provided a display program embodied on a computer readable medium for causing a computer controlling an image forming apparatus to execute processing, the image forming apparatus including a display portion having a display area of a predetermined size and a storage portion to store a display screen for display on the display portion, wherein the processing includes the steps of: reading the display screen for display on the display portion from the storage portion; when a first area included in the read display screen includes, as an item to be displayed, a variable display item for which an arbitrary number of data pieces are displayed, acquiring the number of data pieces for display as the variable display item; changing a size of a field for the variable display item based on the acquired number of data pieces; and based on the size of the first area after the change in size of the field for the variable display item, modifying the read display screen to a display screen in which the first area after the change in size of the field for the variable display item and a second area different from the first area are arranged.

According to yet another aspect of the present invention, there is provided a screen generating program embodied on a computer readable medium for causing a computer controlling an image forming apparatus provided with a display portion having a display area of a predetermined size to execute processing including the steps of: accepting user identification information for identification of a user; accepting designation of at least one of a plurality of display items; determining a size of a first area based on a display size predetermined for the display item specified by the accepted designation; generating a new display screen having the first area and a second area different from the first area arranged therein based on the determined size of the first area; and storing the generated new display screen in association with the user identification information.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows an overall configuration of an advertisement system according to an embodiment of the present invention.

FIG. 2 is a block diagram showing an example of the hardware configuration of an MFP.

FIG. 3 is a functional block diagram schematically showing the function of a CPU provided in the MFP, together with information stored in an EEPROM.

FIG. 4 shows an example of the configuration of advertisement information.

FIG. 5 is a functional block diagram showing an example of the detailed function of a display control portion.

FIG. 6 is a flowchart illustrating an example of the flow of customized screen generation processing.

FIG. 7 is a flowchart illustrating an example of the flow of screen display processing.

FIG. 8 is a flowchart illustrating an example of the flow of processing under job execution.

FIG. 9 is a flowchart illustrating an example of the flow of screen modification processing.

FIG. 10 is a first diagram showing an example of a display screen.

FIGS. 11 and 12 each show an example of a modified display screen.

FIG. 13 is a second diagram showing an example of a display screen.

FIGS. 14 and 15 each show an example of a modified display screen.

FIG. 16 is a flowchart illustrating an example of the flow of advertisement-related processing.

FIG. 17 shows an example of a screen on which a motion advertisement is displayed in an enlarged manner.

### DESCRIPTION OF THE PREFERRED EMBODIMENTS

Embodiments of the present invention will now be described with reference to the drawings. In the following description, like reference characters denote like parts, which have like names and functions, and therefore, detailed description thereof will not be repeated.

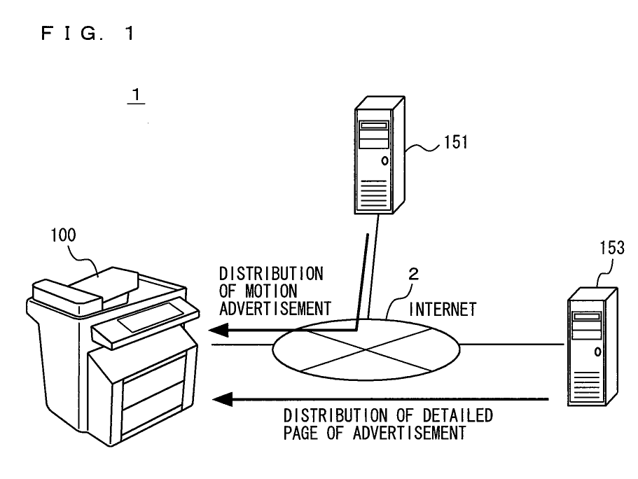

FIG. 1 schematically shows an advertisement system according to an embodiment of the present invention. Referring to FIG. 1, an advertisement system 1 includes an MFP (Multi-Function Peripheral) 100, an advertisement server 153 managed by an advertiser, and a distribution server 151 managed by a content provider, which are connected to the Internet 2. Advertisement server 153 and distribution server 151 are provided by typical computers having well-known hardware configurations and functions, the description of which will not be provided here.

Distribution server 151 stores advertisement information transmitted from advertisement server 153, upon request from advertisement server 153. The advertisement information includes moving images. There are two types of moving images: a long-version motion advertisement, and a digest-version motion advertisement. The moving images for the long-version motion advertisement take a longer reproduction time than those for the digest-version motion advertisement. The advertisement information also includes a URL for a web page stored in advertisement server 153. The web pages stored in advertisement server 153 include, for example, a web page describing details of products, and a web page for selling products by mail order. The advertisement information further includes a static image for a corresponding company. It is noted that the advertisement information may include, instead of the static image for the company, a URL for a web page for printing the static image.

While a single advertisement server 153 is shown in FIG. 1, there may be more than one advertisement server 153. Distribution server 151 receives and stores advertisement information from a respective advertisement server 153. Distribution server 151 transmits advertisement information to an MFP 100 which requested the same, or to an MFP 100 registered in advance. MFP 100 receives the advertisement information transmitted from distribution server 151 and stores the same in an EEPROM. MFP 100 displays the stored advertisement information at a predetermined timing. Specific processing carried out by MFP 100 for displaying the advertisement information will be described below.

While the present embodiment includes MFP 100 as an example of the image forming apparatus, the image forming apparatus may be a printer, a facsimile machine or the like, as long as it has a data processing function.

Further, while the example shown here has MFP 100, distribution server 151 and advertisement server 153 connected via the Internet 2, a local area network (LAN), a dedicated line or the like may replace the Internet 2. Furthermore, the connection with the Internet 2 may be by wire or wireless.

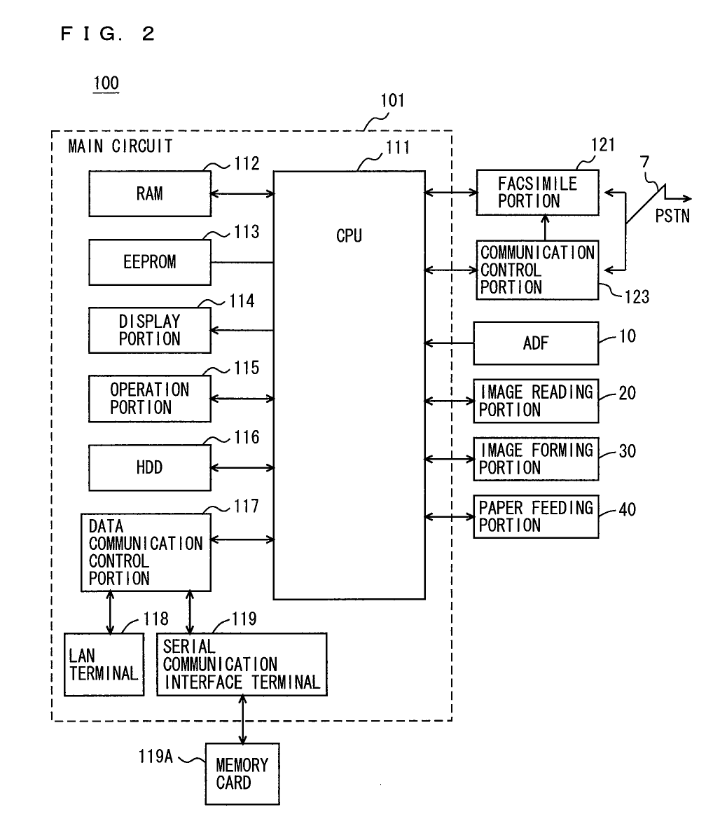

FIG. 2 is a block diagram showing an example of the hardware configuration of an MFP. Referring to FIG. 2, an MFP 100 includes a main circuit 101, a facsimile portion 121, a communication control portion 123, an automatic document feeder (ADF) 10, an image reading portion 20, an image forming portion 30, and a paper feeding portion 40. ADF 10 delivers a plurality of originals mounted on an original platform one by one to image reading portion 20. In response, image reading portion 20 reads image information of photograph, character, picture and the like from the original in an optical manner to acquire image data.

Image forming portion 30, in receipt of the image data, forms an image on a sheet of paper based on the image data. Image forming portion 30 forms an image in color using toners of four colors of cyan, magenta, yellow and black. Alternatively, it forms an image in monochrome using the toner of any of the four colors. Paper feeding portion 40 stores sheets of paper, and supplies them one by one to image forming portion 30.

Main circuit 101 includes a central processing unit (CPU) 111, a RAM (Random Access Memory) 112 used as a working area for CPU 111, an EEPROM (Electronically Erasable Programmable Read Only Memory) 113 for storing a program executed by CPU 111 and the like, a display portion 114, an operation portion 115, a hard disk drive (HDD) 116 as a mass storage, and a data communication control portion 117. CPU 111 is connected with display portion 114, operation portion 115, HDD 116, and data communication control portion 117, and is responsible for overall control of main circuit 101. CPU 111 is also connected with facsimile portion 121, communication control portion 123, ADF 10, image reading portion 20, image forming portion 30, and paper feeding portion 40, and is responsible for overall control of MFP 100.

Display portion 114 is a display such as a liquid crystal display (LCD), an organic electro-luminescence display (ELD) or the like, and displays an instruction menu for the user, information about acquired image data, and others. Operation portion 115 is provided with a plurality of keys, and accepts input of data such as instructions, characters and numerical characters, according to the key operations of the user. Operation portion 115 includes a touch panel provided on display portion 114. Display portion 114 and operation portion 115 constitute an operation panel.

Data communication control portion 117 includes a LAN terminal 118 that is an interface for communication according to a communication protocol such as TCP (Transmission Control Protocol) or UDP (User Datagram Protocol), and a serial communication interface terminal 119 for serial communication. Data communication control portion 117 transmits and receives data to and from an external apparatus connected to LAN terminal 118 or serial communication interface terminal 119, in accordance with an instruction from CPU 111.

When a LAN cable for connection to the Internet 2 is connected to LAN terminal 118, data communication control portion 117 communicates with distribution server 151 or advertisement server 153 via LAN terminal 118, and receives advertisement information from distribution server 151 or advertisement server 153.

CPU 111 controls data communication control portion 117 to read a program to be executed by CPU 111 from a memory card 119A, and stores the read program in RAM 112 for execution. It is noted that the recording medium for storing the program to be executed by CPU 111 is not restricted to memory card 119A. It may be a flexible disk, a cassette tape, an optical disc (CD-ROM (Compact Disc-ROM), MO (Magnetic Optical Disc), MD (Mini Disc), DVD (Digital Versatile Disc)), an IC card, an optical card, or a semiconductor memory such as a masked ROM, an EPROM (Erasable Programmable ROM), an EEPROM (Electronically EPROM), or the like.

Alternatively, CPU 111 may download the program from a computer connected to the Internet 2 and store the same in HDD 116, or a computer connected to the Internet 2 may write the program to HDD 116, and thereafter, the program stored in HDD 116 may be loaded to RAM 112 for execution by CPU 111. As used herein, the “program” includes, not only the program directly executable by CPU 111, but also a source program, a compressed program, an encrypted program, and others.

Communication control portion 123 is a modem for connecting CPU 111 to public switched telephone networks (PSTN) 7. MFP 100 is assigned a telephone number in PSTN 7 in advance, and is communicable with a computer connected to PSTN 7. CPU 111 may communicate with distribution server 151 or advertisement server 153 directly through PSTN 7, or indirectly via a computer of a provider connected to PSTN 7. PSTN 7 may be replaced with a communication network of mobile phones or the like.

When there is a call from a facsimile machine connected to PSTN 7 to the telephone number assigned to MFP 100, communication control portion 123 detects the call. Upon detection of the call, communication control portion 123 establishes the call to enable communication of facsimile portion 121.

Facsimile portion 121 is connected to PSTN 7, and transmits facsimile data to or receives facsimile data from PSTN 7. Facsimile portion 121 converts the received facsimile data to print data that can be printed by image forming portion 30, and outputs the same to image forming portion 30. In response, image forming portion 30 prints the facsimile data received by facsimile portion 121 onto a sheet of paper. Further, facsimile portion 121 converts the data stored in HDD 116 to facsimile data, and outputs the same to a facsimile machine or another MFP connected to PSTN 7. In this manner, it is possible to output the data stored in HDD 116 to the facsimile machine or the other MFP. As such, MFP 100 has the facsimile transmitting/receiving function.

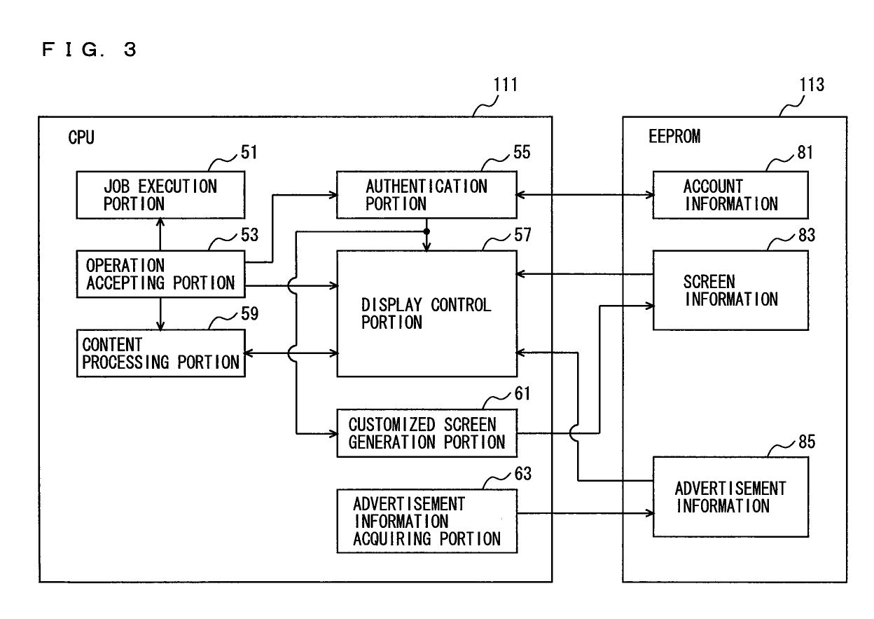

FIG. 3 is a functional block diagram schematically showing the function of a CPU provided in the MFP, together with information stored in the EEPROM. Referring to FIG. 3, a CPU 111 includes: an operation accepting portion 53 to accept an operation; a job execution portion 51 to execute a job in accordance with the accepted operation; an authentication portion 55 for authentication of a user who is an operator; a display control portion 57 to control display portion 114; a customized screen generation portion 61 to generate an operation screen unique to a respective user; an advertisement information acquiring portion 63; and a content processing portion 59 to carry out predetermined processing in response to advertisement information.

EEPROM 113 stores account information 81, screen information 83, and advertisement information 85. Account information 81 includes information for use in authentication of a user who uses MFP 100, such as a user ID, password and the like. Screen information 83 includes display screens to be displayed on display portion 114. The display screens include an operation screen for inputting a setting value necessary for a job to be executed by job execution portion 51, which will be described later, a menu screen for reading an operation screen, and a status display screen for displaying a status during the time in which job execution portion 51 is executing a job.

Display control portion 57 controls display portion 114. It reads a display screen from screen information 83 stored in EEPROM 113, and displays the display screen on display portion 114.

When a user inputs an operation to operation portion 115 according to the operation screen displayed on display portion 114, operation accepting portion 53 accepts the operation from operation portion 115. Operation accepting portion 53 outputs the accepted operation to job execution portion 51, display control portion 57, and content processing portion 59.

Authentication portion 55 accepts the user ID and the password input to operation portion 115, and compares them with account information 81. If account information 81 includes a set of user ID and password matching the input set of user ID and password, authentication portion 55 authenticates the user, and outputs the user ID to display control portion 57 and customized screen generation portion 61.

Job execution portion 51 executes a job in accordance with an operation input from operation accepting portion 53. The job may be a scanning job to cause image reading portion 20 to read an image of an original, a copying job to cause image forming portion 30 to form the original image read by image reading portion 20, and a printing job to cause image forming portion 30 to form an image on a sheet of paper based on image data stored in HDD 116. Upon execution of a job, job execution portion 51 receives a setting value from operation accepting portion 53. The setting value may include: in the case of a scanning job, a size of an original to be read, resolution for reading, an original image and the like; in the case of a copying job, a size of a sheet of paper on which an image is to be formed, scale of enlargement or reduction, image quality including whether to copy in color or monochrome and the like; and in the case of a printing job, a size of a sheet of paper, image quality and the like. When the user is authenticated by authentication portion 55, the job executed by job execution portion 51 is regarded as one that is executed in accordance with an operation input to operation portion 115 by the authenticated user.

Customized screen generation portion 61 generates an operation screen unique to a user, and stores the same as screen information 83 in EEPROM 113. Customized screen generation portion 61 receives a user ID of the user authenticated by authentication portion 55. Customized screen generation portion 61 generates a display screen (customized screen) having items arranged therein according to display items accepted by operation accepting portion 53, and stores the customized screen in association with the user ID in EEPROM 113.

The customized screen generated by customized screen generation portion 61 includes at least a first area. Customized screen generation portion 61 generates the first area by arranging the display items in accordance with the display items accepted by operation accepting portion 53. The display items include items for setting conditions for execution of the scanning, copying, facsimile, and printing functions provided for MFP 100, and an item for displaying a status of execution of any of those functions. Parts such as input fields or buttons of predetermined sizes are prepared for the respective display items, and the parts are arranged as appropriate to generate the first area. After generating the first area, customized screen generation portion 61 arranges the first area on the customized screen of a size that can be displayed on display portion 114, and determines the remaining area on the customized screen as a second area. It is desirable that the second area is of a rectangular shape. The second area is assigned as the area for displaying advertisement information, which will be described later. If the remaining area other than the first area on the display screen does not satisfy a predetermined size requirement, customized screen generation portion 61 does not determine the second area.

When a user ID of the user authenticated by authentication portion 55 is input, if a customized screen associated with the user ID is stored in screen information 83 in EEPROM 113, display control portion 57 reads that customized screen in preference to any other display screens, and displays the read screen on display screen 114.

When data communication control portion 117 receives advertisement information transmitted from distribution server 151, advertisement information acquiring portion 63 receives the advertisement information from data communication control portion 117. Advertisement information acquiring portion 63 stores the advertisement information in EEPROM 113. In this manner, advertisement information 85 is stored in EEPROM 113. Advertisement information acquiring portion 63 may request distribution server 151 to transmit the advertisement information at regular intervals. Alternatively, the IP address of MFP 100 may be registered at distribution server 151, and distribution server 151 may transmit the advertisement information to MFP 100 unilaterally. Frequent updating of advertisement information 85 allows EEPROM 113 to store latest advertisement information 85.

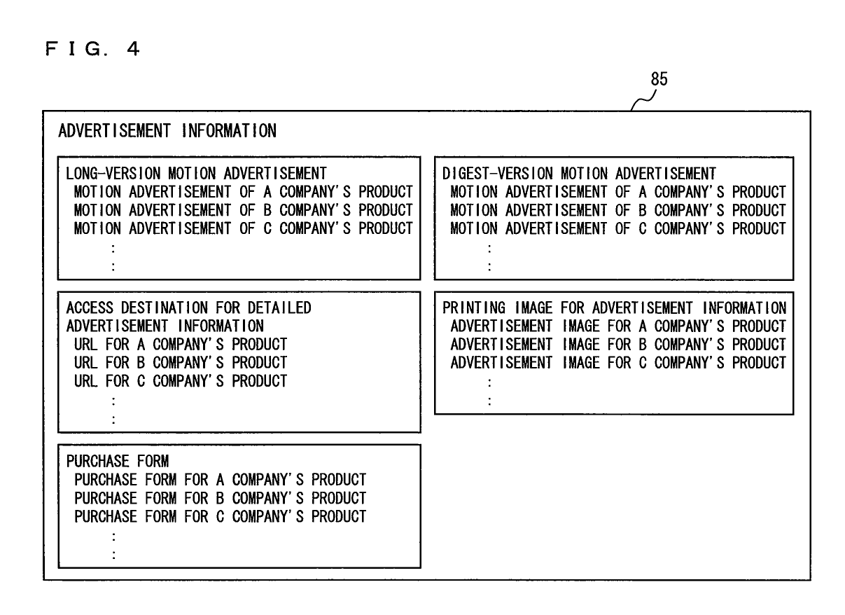

FIG. 4 shows an example of the configuration of the advertisement information. Referring to FIG. 4, the advertisement information includes a long-version motion advertisement, a digest-version motion advertisement, an access designation for detailed advertisement information, a printing image of advertisement information, and a purchase form. The long-version motion advertisement and the digest-version motion advertisement each include moving images for advertising a product for a respective company. The long-version motion advertisement is longer in reproduction time than the digest-version motion advertisement.

The access designation for detailed advertisement information is associated with the digest-version and long-version motion advertisements, and includes a URL for the web page containing detailed information of the product of the company the same as that of the digest-version and long-version motion advertisements.

The printing image of advertisement information is an image for printing, associated with the digest-version and long-version motion advertisements, for the product of the company the same as that of the digest-version and long-version motion advertisements. The advertisement information may include, instead of the printing image of advertisement information, a URL for the web page, associated with the digest-version and long-version motion advertisements, for printing an image of the product of the company the same as that of the digest-version and long-version motion advertisements.

The purchase form, associated with the digest-version and long-version motion advertisements, is a URL for the web page for purchasing the product of the company the same as that of the digest-version and long-version motion advertisements.

Returning to FIG. 3, display control portion 57 successively reads and displays the moving images of the digest-version motion advertisements in advertisement information 85 in a second area on the display screen. In this case, the second area includes buttons assigned with predetermined processing. The predetermined processing include processing of enlarging the motion advertisement, displaying detailed information of the advertisement, saving the long-version motion advertisement as well as the detailed information of the advertisement, printing an image of the product, transferring the detailed information of the advertisement, and accessing a purchase form.

When an instruction to perform the processing of enlarging the motion advertisement is input to operation portion 115 via a button assigned for the processing, content processing portion 59 reads from advertisement information 85 the long-version motion advertisement corresponding to the moving images of the digest-version motion advertisement being displayed in the second area of the display screen at that time. Then, it causes display control portion 57 to display the read moving images of the long-version motion advertisement on the display area of display portion 114 in a full screen display mode. For example, when a digest-version motion advertisement of an A company's product is being displayed as the moving images of the digest-version motion advertisement, a long-version motion advertisement of the A company's product is read as the moving images of the long-version motion advertisement, and displayed on display portion 114 in a full screen display mode.

Content processing portion 59 executes predetermined processing for advertisement information 85. Specifically, when an instruction to perform the processing of displaying detailed information of the advertisement is input to operation portion 115 via a button assigned therefor, content processing portion 59 reads from advertisement information 85 an access destination for detailed advertisement information corresponding to the moving images of the digest-version motion advertisement being displayed in the second area of the display screen at that time. It then controls data communication control portion 117 to download the web page specified by the URL of the read access destination for detailed advertisement information, and causes display control portion 57 to display the web page on the display area of display portion 114 in a full screen display mode. For example, when a motion advertisement for an A company's product is being displayed as the moving images of the digest-version motion advertisement, the web page specified by the URL for the A company's product is downloaded and displayed on display portion 114 in a full screen display mode. The full screen display mode refers to a display mode where an image is displayed on an area having at least one of vertical size and horizontal size matching that of the display area of display portion 114. The full screen display mode provides a transition button for allowing transition to another screen.

When an instruction to perform the processing of saving the long-version motion advertisement and detailed information of the advertisement is input to operation portion 115 via a button assigned therefor, content processing portion 59 reads from advertisement information 85 the long-version motion advertisement and the access destination for detailed advertisement information corresponding to the moving images of the digest-version motion advertisement being displayed in the second area of the display screen at that time. Then, it controls data communication control portion 117 to download the web page specified by the URL of the read access destination for detailed advertisement information, and stores the read long-version motion advertisement and the downloaded web page in a predetermined area in HDD 116. For example, when a digest-version motion advertisement of an A company's product is being displayed as the moving images of the digest-version motion advertisement, a long-version motion advertisement of the A company's product is read as the moving images of the long-version motion advertisement and the web page specified by the URL for the A company's product is downloaded, and the long-version motion advertisement of the A company's product and the web page specified by the URL for the A company's product are stored in an area (a user BOX) in HDD 116 allocated in advance to the user who is operating.

When an instruction to perform the processing of printing a product image is input to operation portion 115 via a button assigned therefor, content processing portion 59 reads from advertisement information 85 a printing image of advertisement information corresponding to the moving images of the digest-version motion advertisement being displayed in the second area of the display screen at that time. Then, it causes image forming portion 30 to form the read printing image of advertisement information on a sheet of paper. For example, when a motion advertisement of an A company's product is being displayed as the moving images of the digest-version motion advertisement, the advertisement image of the A company's product is read, and then formed on a sheet of paper by image forming portion 30.

When an instruction to perform the processing of transferring detailed information of the advertisement is input to operation portion 115 via a button assigned therefor, content processing portion 59 reads from advertisement information 85 an access destination for detailed advertisement information corresponding to the moving images of the digest-version motion advertisement being displayed in the second area of the display screen at that time. Then, it controls data communication control portion 117 to download the web page specified by the URL of the read access destination for detailed advertisement information. Further, it controls data communication control portion 117 to transmit the web page to a transmission destination input to operation portion 115. For example, when a motion advertisement of an A company's product is being displayed as the moving images of the digest-version motion advertisement, the web page specified by the URL for the A company's product is downloaded, and an e-mail having the e-mail address input to operation portion 115 by the user as its destination and having the downloaded web page as its attached file is generated and transmitted.

When an instruction to perform the processing of accessing a purchase form is input to operation portion 115 via a button assigned therefor, content processing portion 59 reads from advertisement information 85 a purchase form corresponding to the moving images of the digest-version motion advertisement being displayed in the second area of the display screen at that time. Then, it activates a browsing program to access the URL for the read purchase form. For example, when a motion advertisement of an A company's product is being displayed as the moving images of the digest-version motion advertisement, the web page specified by the URL of the purchase form for the A company's product is downloaded and displayed on display portion 114 in a full screen display mode. Thereafter, the browsing program is used to communicate with advertisement server 153 specified by the URL of the purchase form for the A company's product. This allows the user to go through procedure for purchasing the A company's product.

Further, content processing portion 59 may cause display control portion 57 to display moving images of the long-version motion advertisement on the display area of display portion 114 in a full screen display mode, at any prescribed timing besides the case where an instruction to enlarge the motion advertisement is input to operation portion 115 via the button assigned therefor. The prescribed timing may be at the start of the period during which an operation cannot be accepted by operation portion 115. The relevant period may be, e.g., the period during which facsimile portion 121 is transmitting or receiving facsimile data, the period during which preparation processing for stabilizing the image formed by image forming portion 30 is being performed, or the period during which communication is being performed with another computer connected to the Internet 2 via data communication control portion 117. The communication period includes the period during which scanned data or data stored in HDD 116 is being transmitted, and the period during which remote control is effective. Displaying the advertisement on display portion 114 in a full screen display mode while the user is unable to make any operation enables effective use of the user's waiting time.

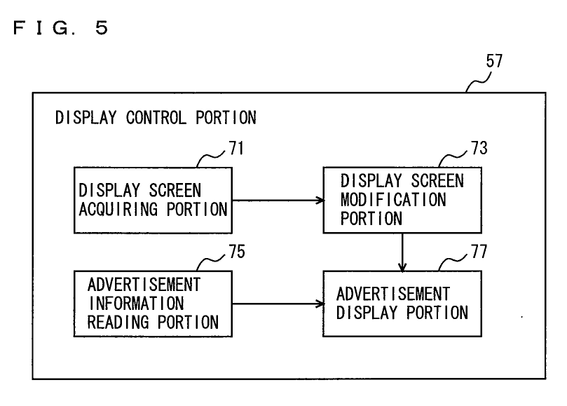

FIG. 5 is a functional block diagram showing an example of the detailed function of the display control portion. Referring to FIG. 5, display control portion 57 includes a display screen acquiring portion 71 to acquire a display screen for display on display portion 114, a display screen modification portion 73 to modify the acquired display screen, an advertisement information reading portion 75 to read advertisement information, and an advertisement display portion 77 to display the advertisement information on a display screen.

Display screen acquiring portion 71 reads a display screen for display on display portion 114 from screen information 83 in EEPROM 113. At an initial stage where MFP 100 is reset, display screen acquiring portion 71 reads a menu screen, and subsequently, when an operation screen is selected at the menu screen, it reads the selected operation screen. During the time when job execution portion 51 is executing a job, display screen acquiring portion 71 reads a status display screen. Display screen acquiring portion 71 outputs the read display screen to display screen modification portion 73. Further, when a user ID is input from authentication portion 55 and if a customized screen corresponding to the display screen to be read is stored in screen information 83, display screen acquiring portion 71 reads the customized screen in preference to the display screen. Display screen acquiring portion 71 outputs the read customized screen to display screen modification portion 73.

When the first area in the display screen input from display screen acquiring portion 71 includes a variable display item as an item to be displayed, display screen modification portion 73 modifies the display screen. The variable display item refers to a display item having an arbitrary number of data pieces to be displayed therefor. Examples include a registered job display item that displays any job registered on MFP 100. The registered job refers to a job for which an execution instruction has been input but which is waited and yet to be executed. Each variable display item included in a display screen stored in screen information 83 is assigned a field of a size enabling display of a predetermined displayable number of data pieces at one time. For example, the field for the registered job display item is set to a size in which information (job names, user IDs and others) of five registered jobs can be displayed at a time.

Display screen modification portion 73 acquires data to be displayed for the variable display item. If the number of the acquired data pieces is smaller than a preset number of data pieces displayable for the variable display item, display screen modification portion 73 changes the size of the field for the variable display item to a minimum size required to display the acquired data pieces. For example, when the displayable number of data pieces is set to “5” and one data piece is acquired, then the size of the field for the variable display item is changed to a minimum size necessary for displaying one piece of data. With the first area thus reduced in size, the remaining area on the display area is set to be the second area. For each display screen, a plurality of modified display screens are stored in EEPROM 113 according to the respective numbers of data pieces displayable in the field for the variable display item, and display screen modification portion 73 reads one of the display screens corresponding to the number of data pieces. Alternatively, a display screen stored in EEPROM 113 may be subjected to a change in size of the field for the variable display image and a change in arrangement of the items included in the first area, for modification of the display screen. Display screen modification portion 73 outputs the modified display screen to advertisement display portion 77.

In the case where the first area in the display screen input from display screen acquiring portion 71 does not include a variable display item as an item to be displayed, or in the case where although it includes a variable display item, if the number of data pieces to be displayed for the variable display item is not smaller than the displayable number preset for the variable display item, display screen modification portion 73 outputs the display screen input from display screen acquiring portion 71 as it is to advertisement display portion 77 without modification.

Advertisement display portion 77 receives a display screen or a modified display screen from display screen modification portion 73, and receives advertisement information 85 from advertisement information reading portion 75. Advertisement display portion 77 displays moving images of a digest-version motion advertisement in advertisement information 85 in a second area of the display screen. If the display screen does not include the second area, advertisement display portion 77 does not display the moving images of the digest-version motion advertisement in the advertisement information.

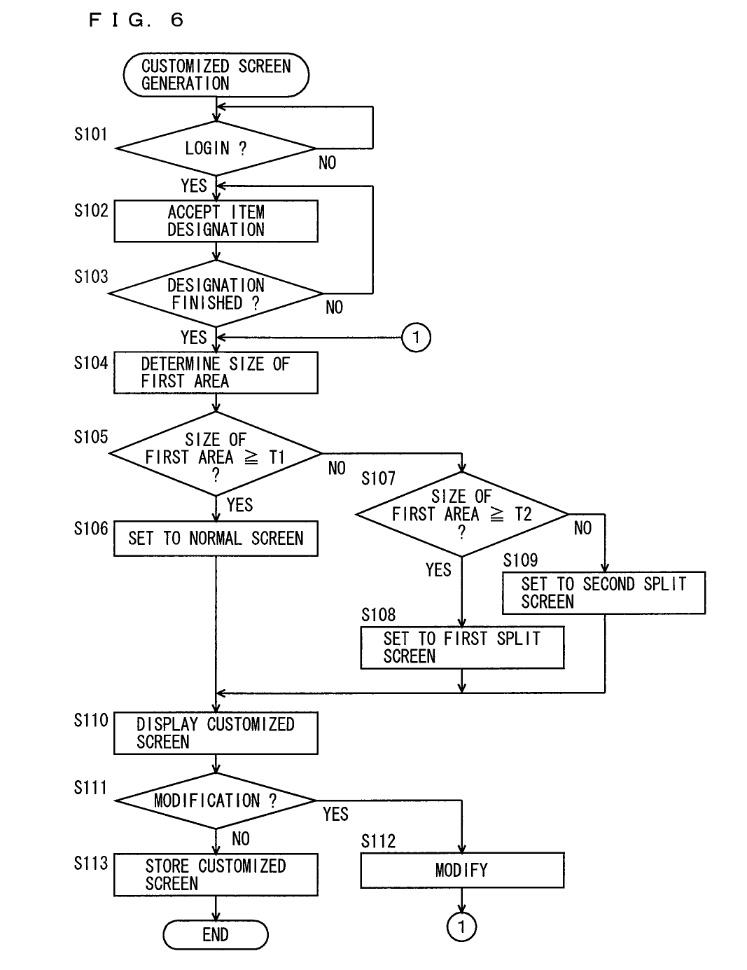

FIG. 6 is a flowchart illustrating an example of the flow of customized screen generation processing. The customized screen generation processing is carried out by CPU 111 as it executes a screen generating program stored in EEPROM 113. Referring to FIG. 6, CPU 111 is in a standby mode until login is permitted (NO in step S101), and once the login is permitted, the process proceeds to step S102. When a user ID and a password are input by the user to operation portion 115, if account information 81 includes a set of user ID and password matching the input set of user ID and password, CPU 111 authenticates the user and permits the login. Otherwise, the login is not permitted. It is noted that login may be permitted to a user whose user ID and password are not registered in account information 81, as a guest user.

In step S102, designation of one or more items is accepted. The items are predetermined as those to be displayed on a display screen. It is also possible to accept an instruction to select at least one of a plurality of predetermined items. In step S103, it is determined whether the designation of the items has been completed. For example, it may be configured such that the instruction to complete the designation of the items is accepted when a user depresses a decision key prepared in operation portion 115. If the designation of the items is completed, the process proceeds to step S104; otherwise, the process returns to step S102.

In step S104, the size of a first area is determined. The first area is generated by arranging the items based on the items accepted in step S102. Parts such as input fields or buttons of a predetermined size are prepared for the respective display items, and they are arranged as appropriate to generate the first area. In this manner, the size of the first area is determined. Preferably, the items are arranged such that the first area has a rectangular shape.

It is then determined whether the size of the first area is equal to or greater than a predetermined threshold value T1 (step S105). The threshold value T1 may be a value for the size of the area in either a longitudinal direction or a lateral direction, preferably the lateral direction. Alternatively, the threshold value may be a value corresponding to both the longitudinal and lateral directions of the area, or it may represent an area occupied by the first area. If the size of the first area is equal to or greater less than the threshold value T1, the process proceeds to step S106; otherwise, the process proceeds to step S107.

In step S106, the customized screen is set to a normal screen, and the process proceeds to step S110. The normal screen is a screen which includes only the first area. This is because, if the size of the first area is not less than the threshold value T1, the remaining portion in the display screen other than the first area would not satisfy a minimum size requirement for the second area.

In step S107, it is determined whether the size of the first area is equal to or greater than a predetermined threshold value T2 which is smaller than the threshold value T1. If the size of the first area is equal to or greater than the threshold value T2, the process proceeds to step S108; otherwise, the process proceeds to step S109.

In step S108, the customized screen is set to a first split screen, and the process proceeds to step S110. The first split screen is a screen which includes both the first and second areas, and in which the size of the second area is smaller than that in a second split screen, which is explained below.

In step S109, the customized screen is set to a second split screen, and the process proceeds to step S110. The second split screen is a screen which includes both the first and second areas, and in which the size of the second area is larger than that in the first split screen.

In step S110, the customized screen is displayed on display portion 114. Then, in step S111, it is determined whether a modification instruction by a user has been accepted. Arrangement or sizes of the items on the customized screen can be changed as the user issues an instruction via a predetermined key in operation portion 115. If the modification instruction is accepted, the process proceeds to step S112; otherwise, the process proceeds to step S113.

In step S112, the customized screen is modified in accordance with the modification instruction, and the process returns to step S104. On the other hand, in step S113, the customized screen is stored in screen information 83 in EEPROM 113, in association with the user ID accepted in step S101. The process is then terminated.

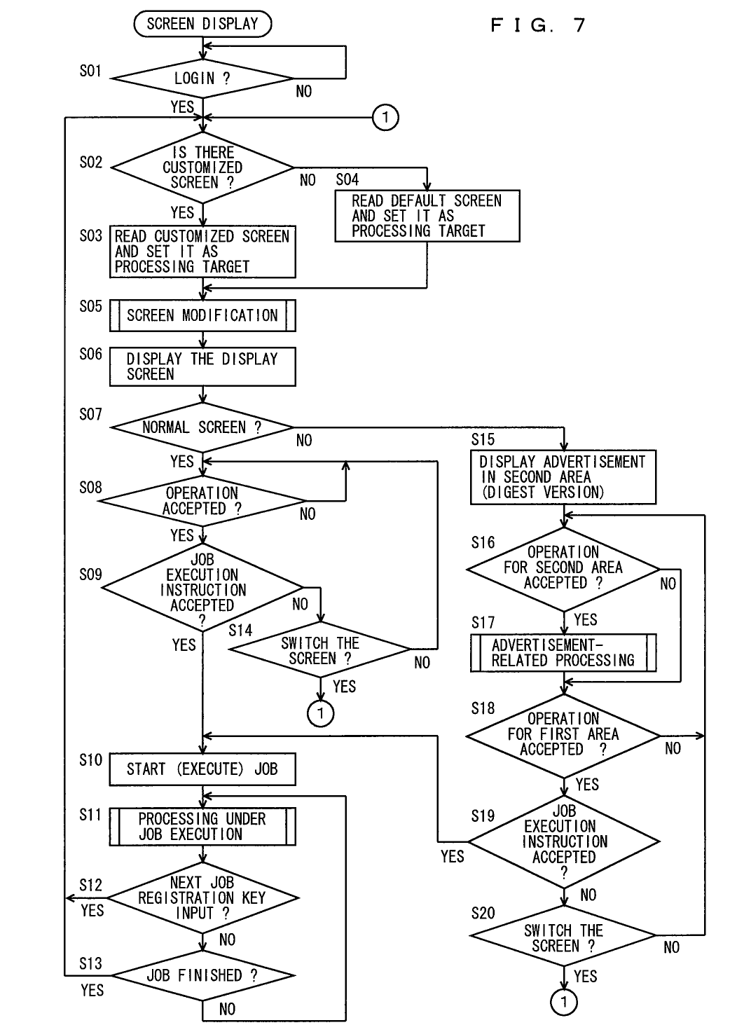

FIG. 7 is a flowchart illustrating an example of the flow of screen display processing. The screen display processing is carried out by CPU 111 as it executes a display program stored in EEPROM 113. Referring to FIG. 7, CPU 111 is in a standby mode until login is permitted (NO in step S01), and once the login is permitted, the process proceeds to step S02. When a user ID and password are input by a user to operation portion 115, CPU 111 authenticates the user if account information 81 includes a set of user ID and password matching the input set of user ID and password, and permits the login. Otherwise, it does not permit the login. It is noted that login may be permitted to a user whose user ID and password are not registered in account information 81, as a guest user.

In step S02, it is determined whether there exists a customized screen for the logged-in user. Specifically, it is determined whether a customized screen associated with the user ID of the logged-in user is stored in screen information 83 in EEPROM 113. If a customized screen for the logged-in user is stored in screen information 83, the process proceeds to step S03; otherwise, the process proceeds to step S04.

In step S03, the customized screen is read from screen information 83 and set as a processing target, and the process proceeds to step S05. Meanwhile, in step S04, a default display screen is read and set as a processing target, and the process proceeds to step S05.

In step S05, screen modification processing is carried out. The screen modification processing, the details of which will be described later, is the processing of changing a normal screen to a first or second split screen, or changing a first split screen to a second split screen, if the first area in the display screen set as the processing target includes a variable display item. In other words, it is the processing of increasing the size of a second area if the display screen includes the second area, and it is the processing of adding a second area in the display screen if the display screen does not include a second area.

In step S06, the display screen having undergone the screen modification processing is displayed on display portion 114. The display screen is any of the normal screen, first split screen, and second split screen. In the following step S07, it is determined whether the display screen is a normal screen. If so, the process proceeds to step S08; otherwise, the process proceeds to step S15.

In step S08, it is determined whether an operation has been accepted. CPU 111 is in a standby mode until an operation is accepted (NO in step S08), and once the operation is accepted (YES in step S08), the process proceeds to step S09. In step S09, it is determined whether the accepted operation is a job execution instruction. If so, the process proceeds to step S10; otherwise, the process proceeds to step S14. In step S14, it is determined whether a screen switching instruction has been accepted. If so, the process returns to step S02 so as to read the switched screen; otherwise, the process returns to step S08.

In step S10, a job is started, and the process proceeds to step S11. In step S11, processing under job execution is carried out. The processing under job execution will be described later in detail. In step S12, it is determined whether a next job registration key has been input. Specifically, it is determined whether the next job registration key displayed on the display screen during the processing under job execution has been designated. If the next job registration key is input, a menu screen for setting a job is read, and the process returns to step S02. Otherwise, the process proceeds to step S13.

In step S13, it is determined whether the job has been finished. If so, the process returns to step S02 to read a menu screen; otherwise, the process returns to step S11.

When the process proceeds to step S15, the first or second split screen is displayed on display portion 114. In step S15, an advertisement is displayed in the second area on the first or second split screen. More specifically, a digest-version motion advertisement is read from advertisement information 85 in EEPROM 113, and the moving images of the digest-version motion advertisement are displayed in the second area. If there are a plurality of digest-version motion advertisements, they are all read and displayed in turn.

In the following step S16, it is determined whether an operation with respect to the second area has been accepted. More specifically, it is determined whether any of buttons in a button group in the second area prepared for inputting instructions to carry out processing has been designated. Here, the button group in the second area for inputting instructions to carry out the processing includes buttons having the characters “PRINT”, “ENLARGE”, “SAVE”, “DETAILS”, “TRANSFER”, and “PURCHASE” respectively indicated thereon.

In the following step S17, advertisement-related processing is carried out. The advertisement-related processing will be described later in detail. Next, it is determined whether an operation with respect to the first area has been accepted (step S18). More specifically, it is determined whether any button included in the first area has been designated. If an operation with respect to the first area is accepted, the process proceeds to step S19; otherwise, the process returns to step S16. In step S19, it is determined whether the accepted operation is a job execution instruction. If so, the process proceeds to step S10; otherwise, the process proceeds to step S20. In step S20, it is determined whether the accepted operation is a screen switching instruction. If so, the process returns to step S02 to read a screen after switching; otherwise, the process returns to step S16.

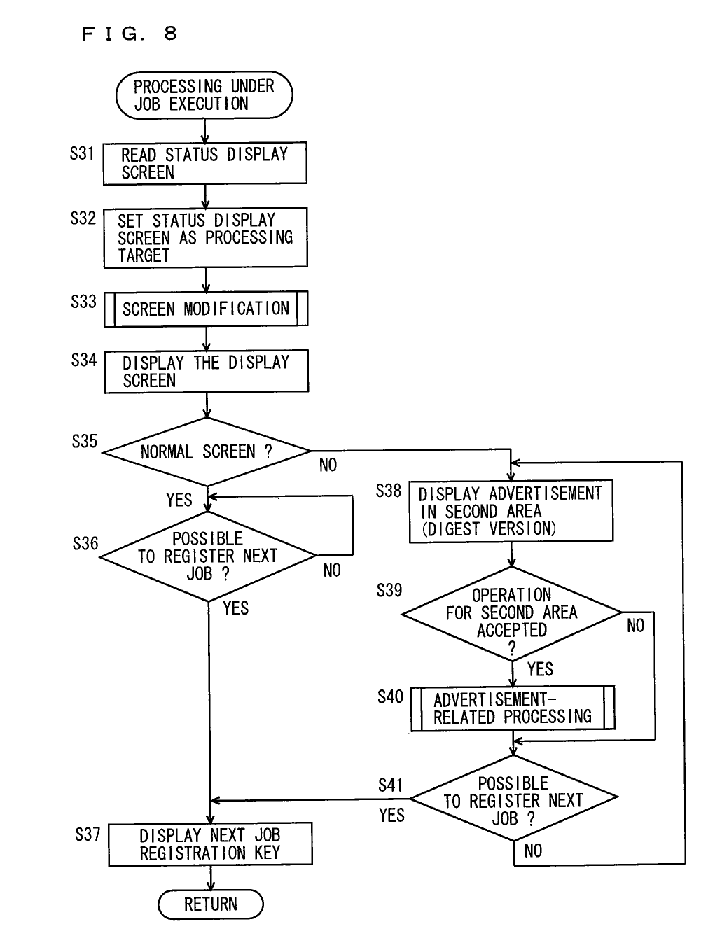

FIG. 8 is a flowchart illustrating an example of the flow of the processing under job execution. The processing under job execution is carried out in step S11 in FIG. 7. Referring to FIG. 8, CPU 111 reads a status display screen from screen information 83 in EEPROM 113 (step S31). The status display screen is a screen for notifying the user of the status of MFP 100 during execution of a job. The status display screen is set as a display screen of a processing target (step S32). Next, the screen modification processing is executed (step S33), which processing will be described later, and the display screen having undergone the screen modification processing is displayed on display portion 114 (step S34).

In the following step S35, it is determined whether the display screen is a normal screen. If so, the process proceeds to step S36; otherwise, the process proceeds to step S38.

In step S36, it is determined whether it is possible to register a next job. CPU 111 is in a standby mode until registration of the next job becomes possible (NO in step S36), and once it is possible to register the next job (YES in step S36), the process proceeds to step S37. In step S37, a next job registration key is displayed on the display screen, and the process returns to the screen display processing.

When the process proceeds to step S38, the first or second split screen is displayed on display portion 114. In step S38, an advertisement is displayed in the second area on the first or second split screen. More specifically, a digest-version motion advertisement is read from advertisement information 85 in EEPROM 113, and the moving images of the digest-version motion advertisement are displayed in the second area. If there exist a plurality of digest-version motion advertisements, they are all read and displayed in turn.

In the following step S39, it is determined whether an operation with respect to the second area has been accepted. More specifically, it is determined whether any button in the button group in the second area prepared for inputting instructions to carry out processing has been designated. Here, the button group in the second area for inputting instructions to carry out the processing includes buttons having the characters “PRINT”, “ENLARGE”, “SAVE”, “DETAILS”, “TRANSFER”, and “PURCHASE” respectively indicated thereon.

In the following step S40, the advertisement-related processing is carried out. The advertisement-related processing will be described later in detail. Next, in step S41, it is determined whether it is possible to register a next job. If it is not possible to register the next job, the process returns to step S38. If it is possible to register the next job, the process proceeds to step S37. In step S37, a next job registration key is displayed on the display screen, and the process returns to the screen display processing.

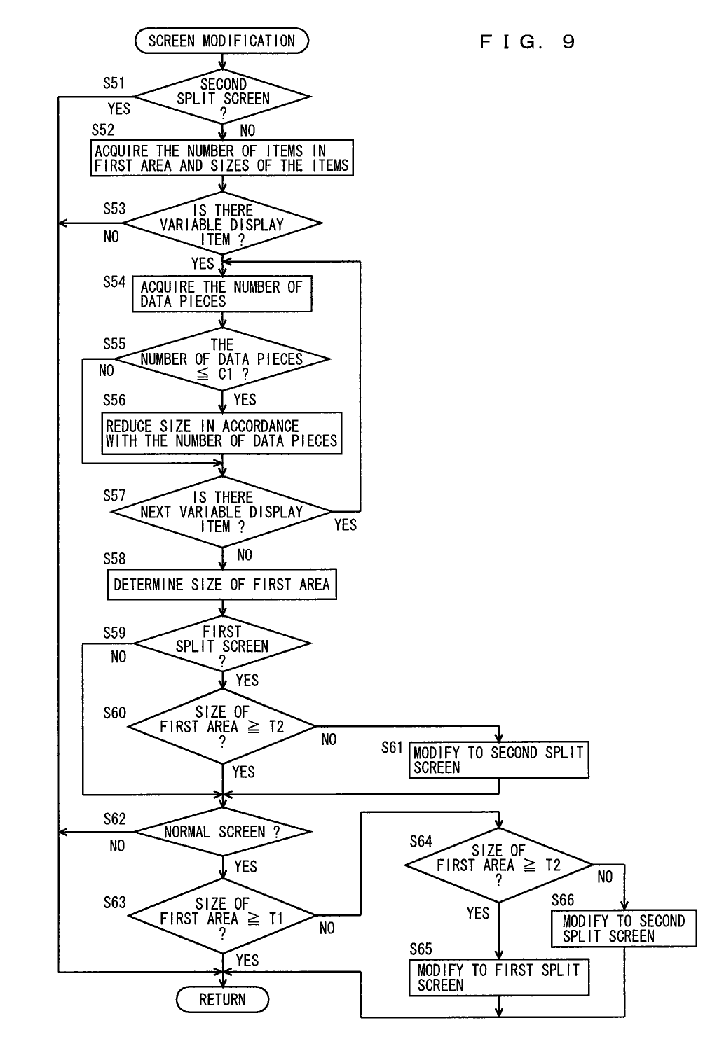

FIG. 9 is a flowchart illustrating an example of the flow of the screen modification processing. The screen modification processing is carried out in step S05 in FIG. 7 and in step S33 in FIG. 8. Referring to FIG. 9, CPU 111 determines whether the display screen being set as a processing target is a second split screen (step S51). If it is not the second split screen, the process proceeds to step S52. If it is the second split screen, the process is terminated, because, in the second split screen, the second area is set to a maximum size, and thus, it is unnecessary to increase the size of the second area. Alternatively, it may be configured to newly generate a split screen having a second area even larger in size than that of the second split screen.

In step S52, the number of items in the first area in the display screen that has been set as a processing target as well as the sizes of the respective items are acquired. It is then determined whether the items included in the first area include a variable display item (step S53). If there is a variable display item, the process proceeds to step S54; otherwise, the process returns to the screen display processing or the processing under job execution. This is because the size of the first area cannot be reduced unless there is a variable display item.

In step S54, the number of data pieces to be displayed for the variable display item is acquired. For example, in the case where the variable display item is a registered job display item, the number of registered jobs is acquired. In the following step S55, the number of data pieces (the number of registered jobs) is compared with a threshold value C1. If the number of data pieces is equal to or smaller than the threshold value C1, the process proceeds to step S56; otherwise, the process proceeds to step S57, skipping step S56. The threshold value C1 is a value predetermined for a respective variable display item. In step S56, the field for the variable display item is reduced in size in accordance with the number of data pieces. This makes it possible to reduce the size of the first area while displaying the data pieces in the first area.

In the following step S57, it is determined whether there exists another variable display item to be a next processing target. If there is a variable display item yet to be processed, the process returns to step S54; otherwise, the process proceeds to step S58. In step S58, the size of the first area is determined based on the field for the variable display item reduced in size. The parts for every display items on the display screen as a processing target, including the field(s) for the variable display item(s) reduced in size, are rearranged to determine the size of the first area. The display items are preferably rearranged such that the first area has a rectangular shape.

It is then determined whether the display screen as a processing target is a first split screen (step S59). If so, the process proceeds to step S60; otherwise, the process proceeds to step S62. In step S60, it is determined whether the size of the first area determined in step S58 is equal to or greater than the threshold value T2. If the size of the first area is equal to or greater than the threshold value T2, the process proceeds to step S62; otherwise, the process proceeds to step S61. If the size of the first area is not less than the threshold value T2, it is determined that a sufficient area for increasing the size of the second area is not left in the display screen.

In step S61, the display screen is modified to a second split screen, and the process proceeds to step S62. The second area in the second split screen is greater in size than the second area in the first split screen. As such, the second area is increased in size, while the data is being displayed in the first area. This makes it possible to attract the user's attention to the advertisement information.

In step S62, it is determined whether the display screen is a normal screen. The normal screen is a screen that does not have a second area. If the display screen is a normal screen, the process proceeds to step S63; otherwise, the process returns to the screen display processing or the processing under job execution. In step S63, it is determined whether the size of the first area determined in step S58 is equal to or greater than the threshold value T1. If the size of the first area is equal to or greater than the threshold value T1, the process returns to the screen display processing or the processing under job execution. Otherwise, the process proceeds to step S64. If the size of the first area is not less than the threshold value T1, it is determined that the remaining area in the display screen will be insufficient for adding the second area.

In step S64, it is determined whether the size of the first area determined in step S58 is equal to or greater than the threshold value T2. If so, the process proceeds to step S65; otherwise, the process proceeds to step S66. If the size of the first area is not less than the threshold value T2, it is determined that the area remaining in the display screen will be sufficient for adding the second area of a small size, although it will not be sufficient to add the second area of a large size. If the size of the first area is smaller than the threshold value T2, it is determined that the remaining area in the display area will be sufficient for adding the second area of a large size. In step S65, the display screen is modified to a first split screen, and the process returns to the screen display processing or the processing under job execution. In step S66, the display screen is modified to a second split screen, and the process returns to the screen display processing or the processing under job execution.

FIG. 10 is a first diagram showing an example of the display screen. FIG. 10 shows an operation screen as an example of the display screen. Referring to FIG. 10, a display screen 201 has fields for displaying a plurality of items. Among them, a field 211 is for displaying a registered job display item, which is a variable display item.

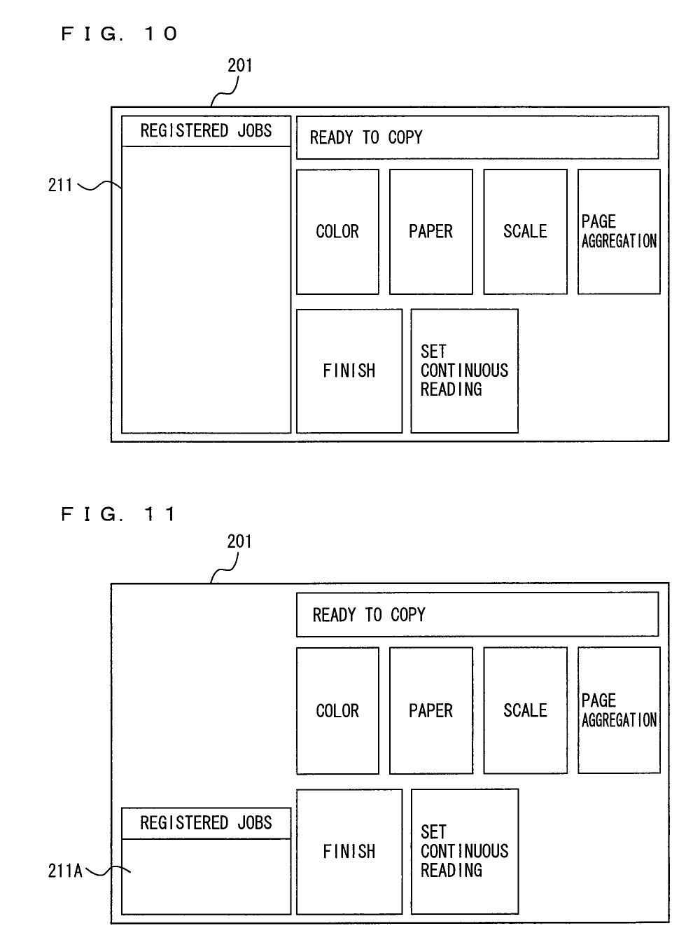

FIG. 11 is a first diagram showing an example of a modified display screen. The modified display screen shown in FIG. 11 corresponds to the case where there is no registered job. Since there is no data to be displayed as the registered job display item on the display screen, field 211 is changed to a field 211A reduced in size.

FIG. 12 is a second diagram showing an example of a modified display screen. Referring to FIG. 12, a modified display screen 201A has a second area 221, which is arranged above the field 211A for displaying the registered job display item. Second area 221 includes an area 223 for displaying moving images of a digest-version motion advertisement, and a button group 225 for inputting instructions to execute processing. Button group 225 includes buttons having the characters “PRINT”, “ENLARGE”, “SAVE”, “DETAILS”, “TRANSFER”, and “PURCHASE” respectively indicated thereon. The button having the characters “PRINT” thereon is assigned with the processing of printing an image of a product. The button having the characters “ENLARGE” thereon is assigned with the processing of displaying moving images of a long-version motion advertisement. The button having the characters “SAVE” thereon is assigned with the processing of saving the long-version motion advertisement as well as detailed information of the advertisement. The button having the characters “DETAILS” thereon is assigned with the processing of displaying the detailed information of the advertisement. The button having the characters “TRANSFER” thereon is assigned with the processing of transferring the detailed information of the advertisement. The button having the characters “PURCHASE” thereon is assigned with the processing of accessing a purchase form.

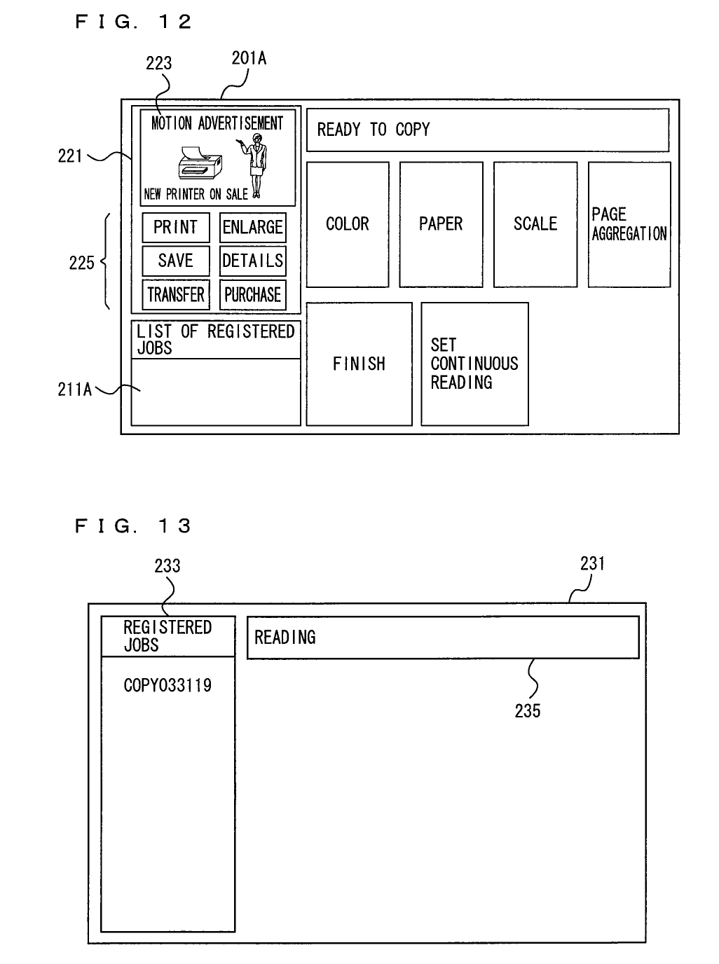

FIG. 13 is a second diagram showing an example of a display screen. FIG. 13 shows a status display screen as an example of the display screen. Referring to FIG. 13, a display screen 231 has a field 235 for displaying a status, and a field 233 for displaying a registered job display item. Both of field 235 for display of the status and field 233 for display of the registered job display item correspond to the variable display items.

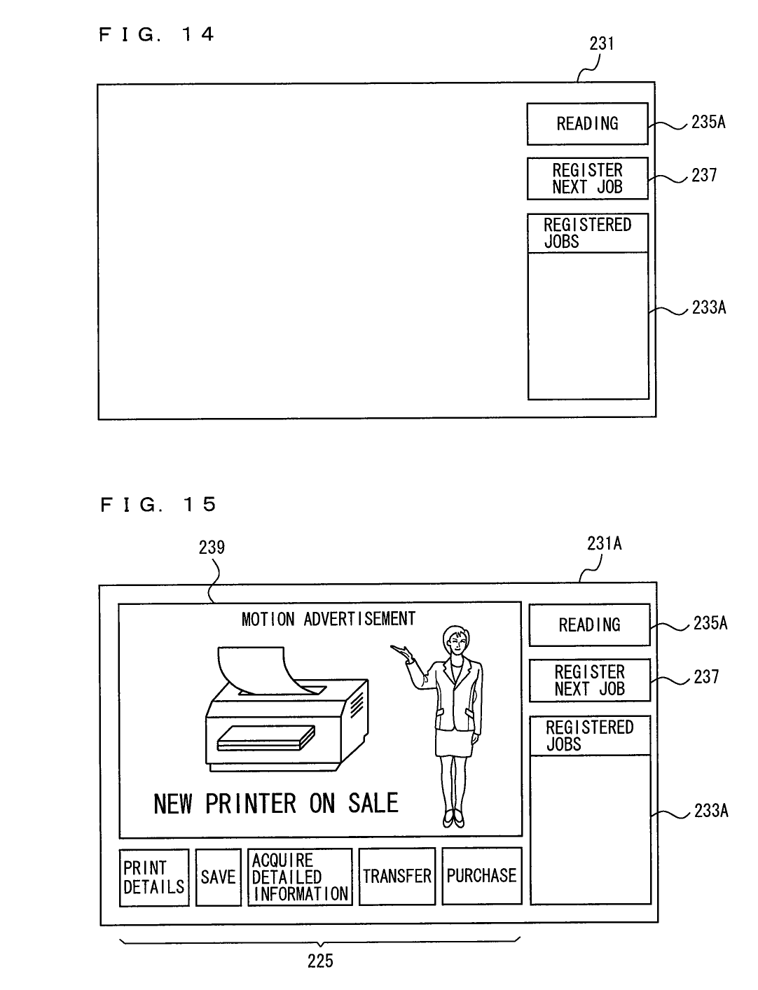

FIG. 14 is a third diagram showing a modified display screen. FIG. 14 shows a modified display screen in the case where there is no registered job. Since there is no data to be displayed as the registered job display item on the display screen, field 233 is changed to a field 233A reduced in size. Field 235 for display of the status, shown in FIG. 13, has the character string “READING” indicated thereon, with a large space available. Thus, field 235 is changed to a field 235A reduced in size. Further, display screen 231 includes a next job registration key 237 having the characters “REGISTER NEXT JOB” thereon. Field 235A, next job registration key 237 and field 233A constitute the first area.

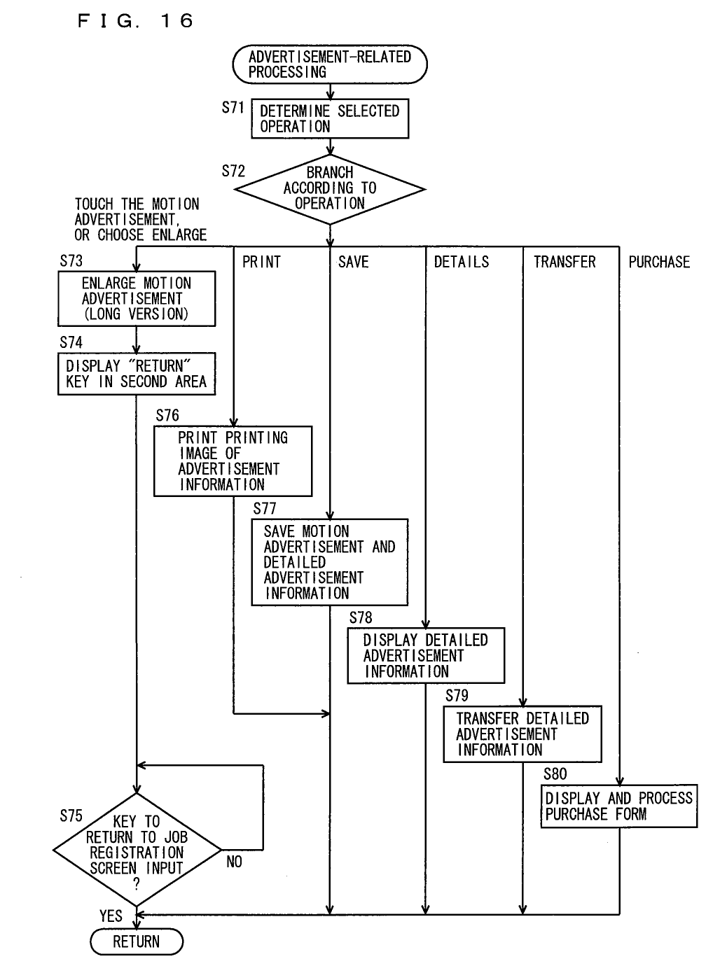

FIG. 15 is a fourth diagram showing an example of a modified display screen. Referring to FIG. 15, a modified display screen 231A includes a second area arranged to the left of the first area composed of field 235A, next job registration key 237 and field 233A. The second area includes an area 239 for displaying moving images of a digest-version motion advertisement, and a button group 225 for inputting instructions to execute processing.

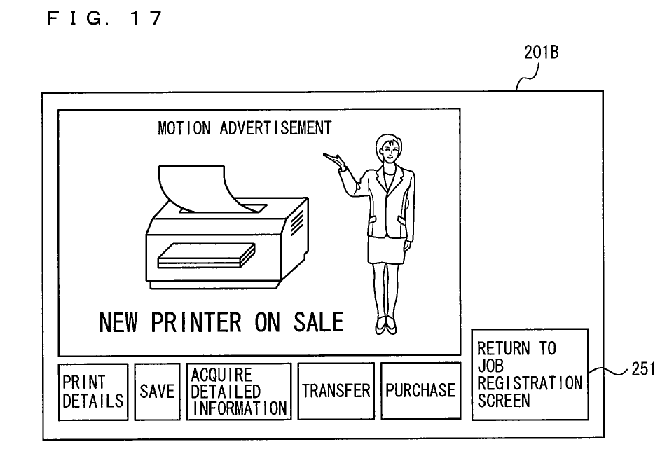

FIG. 16 is a flowchart illustrating an example of the flow of the advertisement-related processing. The advertisement-related processing is carried out in step S17 in FIG. 7 and in step S40 in FIG. 8. Referring to FIG. 16, CPU 111 determines an operation accepted for the second area (step S71). Here, the operation for the second area may include an operation to touch an area in the second area where the moving images are being displayed, and an operation to designate any of the buttons included in the button group in the second area for inputting instructions to execute processing. In step S71, it is determined which operation has been accepted. The button group includes the buttons having the characters “PRINT”, “ENLARGE”, “SAVE”, “DETAILS”, “TRANSFER”, and “PURCHASE” respectively indicated thereon.

In step S72, the process is branched in accordance with the determined operation. If it is the operation to touch the area in the second area on which the moving images are being displayed or the operation to designate the button having the characters “ENLARGE” indicated thereon, the process proceeds to step S73. If it is the operation to designate the button with the characters “PRINT” thereon, the process proceeds to step S76. If it is the operation to designate the button with the characters “SAVE” thereon, the process proceeds to step S77. If it is the operation to designate the button with the characters “DETAILS” thereon, the process proceeds to step S78. If it is the operation to designate the button with the characters “TRANSFER” thereon, the process proceeds to step S79. If it is the operation to designate the button with the characters “PURCHASE” thereon, the process proceeds to step S80.

In step S73, the motion advertisement is enlarged. More specifically, the second area is displayed on display portion 114 in a full screen display mode, the long-version motion advertisement is read from advertisement information 85 in EEPROM 113, and the moving images of the long-version motion advertisement are displayed on the second area. If there are a plurality of long-version motion advertisements, the one corresponding to the digest-version motion advertisement that was being displayed on the second area upon acceptance of the operation is displayed.

In step S74, a “RETURN” key for an instruction to return from the full screen display mode is displayed on display portion 114, and the process proceeds to step S75. More specifically, the “RETURN” key is displayed on the second area. While the “RETURN” key is preferably displayed outside the area for displaying the moving images, if there is no space available outside that area in the full screen display mode, it may be displayed in the area for displaying the moving images in a superimposed manner.

FIG. 17 shows an example of the screen on which the motion advertisement is displayed in an enlarged manner. The screen shown in FIG. 17 is displayed when an operation to touch the area 223 in the second area in which the moving images are displayed or an operation to designate the button having the characters “ENLARGE” indicated thereon has been accepted in the state where the modified display screen (operation screen) shown in FIG. 12 is being displayed. Area 221 in the first split screen 201A is displayed on the screen 201B in a full screen display mode. A “RETURN” key 251 having the characters “RETURN TO JOB REGISTRATION SCREEN” indicated thereon is also displayed.

Returning to FIG. 16, in step S75, CPU 111 is in a standby mode until the “RETURN” key is designated (NO in step S75), and once the “RETURN” key is designated (YES in step S75), the process returns to the screen display processing or the processing under job execution.

In step S76, a printing image of the advertisement information is printed, and the process returns to the screen display processing or the processing under job execution. More specifically, a printing image of the advertisement information corresponding to the moving images of the digest-version motion advertisement being displayed in the second area at the time when the operation was accepted is read from advertisement information 85. Then, the read printing image of the advertisement information is formed on a sheet of paper by image forming portion 30, and the process returns to the screen display processing or the processing under job execution.

In step S77, the motion advertisement and the detailed information of the advertisement are saved, and the process returns to the screen display processing or the processing under job execution. More specifically, the long-version motion advertisement corresponding to the moving images of the digest-version motion advertisement being displayed in the second area at the time when the operation was accepted as well as the access designation for the detailed advertisement information are read from advertisement information 85. Then, data communication control portion 117 is controlled to download a web page specified by the URL of the read access destination for the detailed advertisement information, and the read long-version motion advertisement and the downloaded web page are stored in a predetermined area in HDD 116.

In step S78, the detailed advertisement information is displayed, and the process returns to the screen display processing or the processing under job execution. More specifically, the access destination for detailed advertisement information corresponding to the moving images of the digest-version motion advertisement being displayed in the second area at the time when the operation was accepted is read from advertisement information 85. Then, data communication control portion 117 is controlled to download a web page specified by the URL of the read access destination for the detailed advertisement information, and the downloaded web page is displayed in the second area.

In step S79, the detailed advertisement information is transferred, and the process returns to the screen display processing or the processing under job execution. More specifically, the access destination for detailed advertisement information corresponding to the moving images of the digest-version motion advertisement being displayed in the second area at the time when the operation was accepted is read from advertisement information 85. Then, data communication control portion 117 is controlled to download a web page specified by the URL of the read access destination for detailed advertisement information. Data communication control portion 117 is further controlled to transmit the web page to a transmission destination input to operation portion 115. For example, an e-mail having the e-mail address input to operation portion 115 by the user as its destination and having the downloaded web page as its attached file is generated and transmitted.

In step S80, a purchase form is displayed and the processing for purchasing is executed, and the process returns to the screen display processing or the processing under job execution. More specifically, the purchase form corresponding to the moving images of the digest-version motion advertisement being displayed in the second area at the time when the operation was accepted is read from advertisement information 85. Then, the browsing program is activated to access the URL of the read purchase form. Thereafter, the browsing program is used to communicate with the advertisement server specified by the URL of the purchase form. This allows the user to perform procedure for purchasing the product.

As described above, according to MFP 100 of the present embodiment, the display screens to be displayed on display portion 114 are stored in screen information 83 in EEPROM 113, and CPU 111 includes display control portion 57 that reads a display screen from screen information 83 and displays the same on display portion 114. Display control portion 57 includes display screen modification portion 73 that is configured, when the first area included in the display screen includes a variable display item in which an arbitrary number of data pieces are to be displayed, to acquire the number of data pieces to be displayed for the variable display item, change the size of a field for the variable display item based on the acquired number of data pieces, determine the size of the second area based on the size of the first area after a change in size of the field for the variable display item as well as the size of the display area of display portion 114, and modify the read display screen to a display screen in which the first area after the change in size of the field for the variable display item and the second area of the determined size are arranged. As such, in the case where the number of data pieces to be displayed is small, the display screen is modified from a normal screen to a first or second split screen, or modified from a first split screen to a second split screen. The second area is increased in size when the number of data pieces being displayed is small, whereas the second area is reduced in size when the number of data pieces being displayed is large, whereby the size of the second area can be increased as much as possible. As a result, the advertisement can be made conspicuous as it is displayed on a large area.

Further, MFP 100 accepts designation of at least one item from among a plurality of display items, and determines the size of the first area based on the display size predetermined for the display item specified by the accepted designation. It then determines the size of the second area based on the size of the first area and the size of the display area, and generates a customized screen having the first and second areas arranged therein. It then stores the customized screen in association with the user ID, in screen information 83 in EEPROM 113. Accordingly, it is possible to generate a customized screen customized for each user, having the second area made as large as possible. As a result, a customized screen having a large area for displaying an advertisement, and hence, capable of displaying the advertisement in a conspicuous manner, can be generated.

While the case where an operator operates operation portion 115 has been explained in the present embodiment, the present invention is also applicable to the case where MFP 100 is connected to a LAN or another network and another computer connected to the network remotely controls MFP 100. In this case, a display screen identical to the one displayed on display portion 114 by MFP 100 may be transmitted to the computer via data communication control portion 117.

While MFP 100 has been described in the above embodiment, the present invention may of course be understood as a screen generating method or a screen generating program that causes a computer to execute the processing illustrated in FIG. 6. Further, the present invention may also be understood as a display method or a display program that causes a computer to execute the processing illustrated in FIGS. 7-9 and 16.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An image forming apparatus comprising:
a display portion having a display area of a predetermined size;
a storage portion to store a display screen to be displayed on said display portion; and
a display control portion to read said display screen from said storage portion for display on said display portion,
said display control portion including
a data acquiring portion, when a first area included in said display screen includes, as an item to be displayed, a variable display item for which an arbitrary number of data pieces are displayed, to acquire the number of data pieces for display as said variable display item,
a size change portion to change a size of a field for said variable display item based on said acquired number of data pieces, and
a screen information modification portion to modify said read display screen to a display screen in which said first area after a change in size of the field for said variable display item and a second area different from said first area are arranged, based on the size of said first area after the change in size of the field for said variable display item.

2. The image forming apparatus according to claim 1, wherein
said storage portion further stores a plurality of contents, and
said display control portion includes
a selection portion to select one of said plurality of contents, and
a content display portion to display said selected content in said second area.

3. The image forming apparatus according to claim 2, further comprising a content processing portion to execute processing corresponding to the content; wherein
said second area includes an instruction area for accepting an instruction to cause said content processing portion to execute processing, and
said display control portion, in response to designation of said instruction area, causes said content processing portion to execute processing predetermined corresponding to said content being displayed in said second area and corresponding to said instruction area.

4. The image forming apparatus according to claim 3, wherein said content processing portion acquires a content of another type predetermined corresponding to said content being displayed in said second area.

5. The image forming apparatus according to claim 4, wherein said content processing portion displays said acquired content of the other type on said display portion.

6. The image forming apparatus according to claim 4, wherein said content processing portion displays said acquired content of the other type over a whole area of the display area of said display portion.

7. The image forming apparatus according to claim 4, further comprising an image forming portion to form an image, wherein
said content processing portion causes said image forming portion to form an image based on said acquired content of the other type.

8. The image forming apparatus according to claim 4, further comprising a data transmission portion to transmit data, wherein
said content processing portion causes said data transmission portion to transmit said acquired content of the other type.

9. The image forming apparatus according to claim 4, wherein said content processing portion stores said acquired content of the other type in said storage portion.

10. The image forming apparatus according to claim 2, wherein
said second area includes an instruction area for instructing switching of a content being displayed in the second area, and
said display control portion, in response to designation of said instruction area, acquires a content of another type corresponding to said content being displayed in said second area and displays said acquired content of the other type in said second area.

11. The image forming apparatus according to claim 1, further comprising an operation accepting portion to accept an input of an operation, wherein
in receipt of a predetermined operation from said operation accepting portion, said display control portion displays, on said display portion, an enlarged display screen having said second area increased in size, instead of said display screen.

12. The image forming apparatus according to claim 11, wherein
said enlarged display screen includes an instruction area for inputting an instruction to switch to display said display screen, and
in response to designation of said instruction area, said display control portion displays, on said display portion, said display screen instead of said enlarged display screen.

13. The image forming apparatus according to claim 11, further comprising an image forming portion to form an image, wherein
during a period in which said operation accepting portion is unable to accept an operation, said display control portion displays said enlarged display screen on said display portion instead of said display screen, and
the period in which said operation accepting portion is unable to accept an operation includes a period in which processing for stabilizing an image formed by said image forming portion is being performed.

14. The image forming apparatus according to claim 11, further comprising a communication portion to transmit data to and receive data from an external apparatus, wherein
during a period in which said operation accepting portion is unable to accept an operation, said display control portion displays said enlarged display screen on said display portion instead of said display screen, and
the period in which said operation accepting portion is unable to accept an operation includes a period in which said communication portion is transmitting or receiving data.

15. The image forming apparatus according to claim 1, further comprising a function execution portion to execute a function, wherein
said first area includes, as an item to be displayed, an item for setting a condition for determining a function to be executed by said function execution portion or an item for displaying a status in which the function is being executed by said function execution portion.

16. An image forming apparatus comprising:
a display portion having a display area of a predetermined size;
an identification information accepting portion to accept user identification information for identification of a user;
an item accepting portion to accept designation of at least one of a plurality of display items;
a first area determination portion to determine a size of a first area based on a display size predetermined for said display item specified by said accepted designation;
a screen generation portion to generate a new display screen having said first area and a second area different from said first area arranged based on said determined size of said first area; and
a storage portion to store said generated new display screen in association with said user identification information.

17. The image forming apparatus according to claim 16, further comprising a display control portion, in receipt of said user identification information from said identification information accepting portion, to read said new display screen associated with said accepted user identification information from said storage portion to be displayed on said display portion.

18. A display method executed by an image forming apparatus, said image forming apparatus including a display portion having a display area of a predetermined size and a storage portion to store a display screen for display on said display portion, the method comprising the steps of:
reading said display screen for display on said display portion from said storage portion;
when a first area included in said read display screen includes, as an item to be displayed, a variable display item for which an arbitrary number of data pieces are displayed, acquiring the number of data pieces for display as said variable display item;
changing a size of a field for said variable display item based on said acquired number of data pieces; and
based on the size of said first area after a change in size of the field for said variable display item, modifying said read display screen to a display screen having said first area after the change in size of the field for said variable display item and a second area different from said first area arranged therein.

19. A screen generating method carried out by an image forming apparatus provided with a display portion having a display area of a predetermined size, the method comprising the steps of:
accepting user identification information for identification of a user;
accepting designation of at least one of a plurality of display items;
determining a size of a first area based on a display size predetermined for said display item specified by said accepted designation;
generating a new display screen having said first area and a second area different from said first area arranged therein based on said determined size of said first area; and
storing said generated new display screen in association with said user identification information.

20. A display program embodied on a computer readable medium for causing a computer controlling an image forming apparatus to execute processing, said image forming apparatus including a display portion having a display area of a predetermined size and a storage portion to store a display screen for display on said display portion, said processing including the steps of:
reading said display screen for display on said display portion from said storage portion;
when a first area included in said read display screen includes, as an item to be displayed, a variable display item for which an arbitrary number of data pieces are displayed, acquiring the number of data pieces for display as said variable display item;
changing a size of a field for said variable display item based on said acquired number of data pieces; and
based on the size of said first area after a change in size of the field for said variable display item, modifying said read display screen to a display screen having said first area after the change in size of the field for said variable display item and a second area different from said first area arranged therein.

21. A screen generating program embodied on a computer readable medium for causing a computer controlling an image forming apparatus provided with a display portion having a display area of a predetermined size to execute processing including the steps of:
accepting user identification information for identification of a user;
accepting designation of at least one of a plurality of display items;
determining a size of a first area based on a display size predetermined for said display item specified by said accepted designation;
generating a new display screen having said first area and a second area different from said first area arranged therein based on said determined size of said first area; and
storing said generated new display screen in association with said user identification information.
